(19) United States
(12) Patent Application Publication
(10) Pub. No.: US 2026/0241669 A1
(43) Pub. Date: Aug. 20, 2026

(54) TEMPERED GLASS FILM THAT BLOCKS BLUE LIGHT AND EXCITES RED LIGHT

(71) Applicant: WTL Technology Shenzhen CO., LTD., Shenzhen (CN)

(72) Inventors: Tak Nam LIU, Shenzhen (CN); Siu Yin LIU, Shenzhen (CN)

(21) Appl. No.: 19/084,780

(22) Filed: Mar. 20, 2025

(30) Foreign Application Priority Data
Feb. 18, 2025 (CN) 202510178634.4

(51) Int. Cl. B32B 17/10; B32B 37/26; B32B 38/00; G02B 5/20; G02F 1/017

(52) U.S. Cl. CPC B32B 17/10018; B32B 17/10449; B32B 17/10779; B32B 37/26; B32B 38/0012; G02B 5/208; G02F 1/01791; B32B 2037/268; B32B 2038/0028; B32B 2038/0076; B32B 2255/10; B32B 2307/412; B32B 2307/422; B32B 2307/7376; B32B 2367/00; G02F 2201/086; G02F 2203/05

(57) ABSTRACT

The present invention discloses a tempered glass film that blocks blue light and excites red light, including high aluminum triple strength glass, high transparency OCA, photo-excited carbon quantum dot coating, blue light blocking coating, high transparency PET substrate, silicone layer, and PET release film; in response to the red light films with high color temperature in the market, the present invention adopts carbon quantum dot technology that provides a transmittance of over 90%, which is consistent with PET, glass and other materials, and the film which is completely transparent in the non-excited state does not affect the color performance of the screen.

### CROSS-REFERENCE TO RELATED APPLICATIONS

This application is based upon and claims priority to Chinese Patent Application No. 202510178634.4, filed on Feb. 18, 2025, the entire content of which is incorporated herein by reference.

### TECHNICAL FIELD

The present invention relates to the technical field of mobile phone protective film, specifically to a tempered glass film that blocks blue light and excites red light.

### BACKGROUND

With the popularity of smartphones, mobile phone screens, as the main interface for user interaction, are obviously important but highly susceptible to scratches, impacts, and other damages, which not only affect aesthetics but may also affect the normal use of the phone. Therefore, as consumers' demand for mobile phone screen protection continues to increase, tempered glass film for mobile phones has emerged. “Blue light” refers to a type of blue visible light with a wavelength between 400-500 nanometers, commonly present in the sun, and electronic devices such as mobile phones, computers, and televisions; prolonged exposure to blue light in this wavelength range can cause certain and irreversible damage to the user's retina and therefore, in order to better protect the user's eyes, anti blue light mobile phone films have emerged. Red light eye protection is an innovative eye protection technology that protects and maintains the eyes through its unique physiological mechanism by utilizing the red light within a specific wavelength range (usually 650-670 nanometers), and red light of a specific wavelength can be absorbed by the mitochondria of the retina to provide energy for cells, help improve visual impairment, slow down the aging rate of the retina and improve visual sensitivity.

The existing tempered glass film has the following defects: firstly, the red light film on the market which is still in the emerging stage has relatively single function, only capable of stimulating red light. However, these red light films do not integrate the function of blue light blocking, and cannot simultaneously meet the dual needs of users for red light excitation and blue light blocking; secondly, the red light films available on the market present a light red tone under normal conditions, leading to a high color temperature of the screen, and then affecting the screen's color performance, which is undoubtedly an issue that cannot be ignored for users who pursue high-quality visual experience; thirdly, the base color of blue light blocking materials often appears pale yellow, mainly because of the use of blue light absorption technology. After anti blue light factors are added to the substrate, some of the blue light energy will be automatically absorbed when the blue light of electronic screen passes through these materials. In order to effectively absorb blue light, the lens needs to present the complementary color yellow of blue light. Currently, absorption type blue light blocking lenses on the market generally have a pale yellow base color which, to some extent, affects the user's visual experience.

### SUMMARY

The purpose of the present invention is to provide a tempered glass film that blocks blue light and excites red light, in order to address the problems raised in the background technology mentioned above.

To achieve the above purposes, the present invention provides the following technical solution: a tempered glass film that blocks blue light and excites red light, comprising a high transparency PET substrate, wherein a blue light blocking coating is fixedly connected to an outer wall at a side of the high transparency PET substrate, a photo-excited carbon quantum dot coating is provided at a side of the blue light blocking coating, and a high transparency OCA is provided at a side of the photo-excited carbon quantum dot coating.

As a further technical solution of the present invention, a high-aluminum grade-3 strength glass is fixedly connected to an outer wall at a side of the high transparency OCA.

As a further technical solution of the present invention, a silicone layer is provided on the other side of the high transparency PET substrate, and a PET release film is provided on an outer wall at a side of the silicone layer.

As a further technical solution of the present invention, the high transparency OCA adopts high transparency OCA adhesive having a thickness of 85 microns under the structure.

As a further technical solution of the present invention, the photo-excited carbon quantum dot coating is a new type of nanomaterial, with quantum dot particle size less than 10 nanometers, quantum yield of 30%, purity of 80%, excitation wavelength of 400 nanometers, and emission wavelength of 610 nanometers, and red light quantum dots can change the emission wavelength by adjusting the particle size, that is, smaller quantum dots emit light close to blue, while larger quantum dots emit light close to red.

As a further technical solution of the present invention, the blue light blocking coating is composed of a fluorescent powder, an organic light absorber, an ultraviolet absorber, a resin, and an organic filler, and the mass percentage content of each component is: 10-15% of fluorescent powder, 0-10% of organic light absorber, 0-10% of ultraviolet absorber, 15-20% of inorganic filler, and the rest is resin.

As a further technical solution of the present invention, the blue light blocking coating has a thickness of 15 microns under the structure.

As a further technical solution of the present invention, the high transparency PET substrate is a thin film made of polyethylene terephthalate polymer through biaxial stretching and under the structure, serves as the substrate of anti-peeping layer structure resin, with a thickness of 25 microns.

As a further technical solution of the present invention, the silicone layer is made of silicone resin through thermal curing.

As a further technical solution of the present invention, the PET release film is a PET polyester film that is, under the structure, used as an optical heavy release film with a thickness of 50 microns. compared with the prior art, the present invention has the following beneficial effects: by using the purple light in the band range of 380 nm emitted by the screen, the present invention not only excites red light in the band range of 620-700 nm that is beneficial to the eyes, but also effectively blocks blue light in the band range of 435-440 nm emitted by the screen, and protects the eyes by blocking the harm of blue light to the eyes, and provides more comprehensive eye protection based on the dual function of red light excitation and blue light blocking; in response to the red light films with high color temperature in the market, the present invention adopts carbon quantum dot technology that provides a transmittance of over 90%, which is consistent with PET, glass and other materials, and the film which is completely transparent in the non-excited state does not affect the color performance of the screen. Under the excitation of red light, the screen has the brightness attenuation less than 20%, the color temperature difference less than 200K, and the visible light transmittance at 550 nm greater than 80%, ensuring the stable screen brightness and color, without affecting the screen's normal use, while protecting users' eyes, and in response to the traditional blue light blocking materials with yellowish bottom color, the composite of inorganic nanomaterials and polymer materials can accurately absorb blue light in the band range of 435nm-440 nm, effectively blocking blue light transmission, with a blocking rate greater than 40%, providing effective anti-blue light protection, while ensuring the transmission of visible light of 440nm-780 nm, without affecting the perspective and lighting performance. Compared with red light AB adhesive with limited red light amplification on the market, the present invention increases the amplification of red light band by over 40%, significantly enhancing the eye protection performance of red light.

### BRIEF DESCRIPTION OF THE DRAWINGS

FIG. 1 is a schematic diagram of the structure of each layer of the present invention;

FIG. 2 is a brightness difference diagram of different tempered glass films on OLED screen in various bands;

FIG. 3 is the transmittance of light in the wavelength range of 380-460 nanometers according to the present invention;

FIG. 4 is a schematic diagram of the experiment under a general light source in the present application;

FIG. 5 is a schematic diagram of the experiment under 380 nm designated laser band light source in the present application.

Where: 1. High-aluminum grade-3 strength glass; 2. High transparency OCA; 3. Photo-excited carbon quantum dot coating; 4. Blue light blocking coating; 5. High transparency PET substrate; 6. Silicone layer; 7. PET release film.

### DETAILED DESCRIPTION OF THE EMBODIMENTS

The technical solutions in the embodiments of the present invention will be clearly and completely described below in conjunction with the accompanying drawings. Obviously, the described embodiments are only a part of, not all of, the embodiments of the present invention. Based on the embodiments of the present invention, all other embodiments obtained by the persons having ordinary skill in the art without creative labor are within the scope of protection of the present invention.

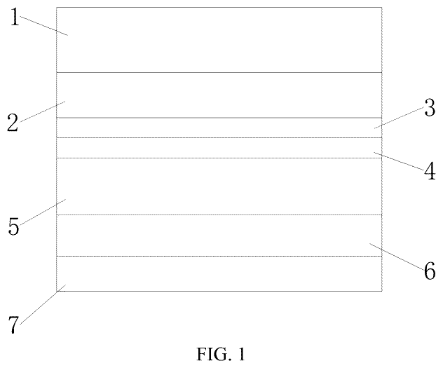

As shown in FIGS. 1-5, the present invention provides an embodiment: a tempered glass film that blocks blue light and excites red light, comprising a high transparency PET substrate 5, wherein a blue light blocking coating 4 is fixedly connected to an outer wall at a side of the high transparency PET substrate 5, a photo-excited carbon quantum dot coating 3 is provided at a side of the blue light blocking coating 4, and a high transparency OCA 2 is provided at a side of the photo-excited carbon quantum dot coating 3; a high-aluminum grade-3 strength glass 1 is fixedly connected to an outer wall at a side of the high transparency OCA 2; a silicone layer 6 is provided on the other side of the high transparency PET substrate 5, and a PET release film 7 is provided on an outer wall at a side of the silicone layer 6; the high transparency OCA 2 is high transparency OCA adhesive having a thickness of 85 microns under the structure; the photo-excited carbon quantum dot coating 3 is a new type of nanomaterial, with quantum dot particle size less than 10 nanometers, quantum yield of 30%, purity of 80%, excitation wavelength of 400 nanometers, and emission wavelength of 610 nanometers, and red light quantum dots can change the emission wavelength by adjusting the particle size, that is, smaller quantum dots emit light close to blue, while larger quantum dots emit light close to red; the blue light blocking coating 4 is composed of a fluorescent powder, an organic light absorber, an ultraviolet absorber, a resin, and an organic filler, and the mass percentage content of each component is: 10-15% for fluorescent powder, 0-10% for organic light absorber, 0-10% for ultraviolet absorber, 15-20% for inorganic filler, and rest for resin; the blue light blocking coating 4 has a thickness of 15 microns under the structure; the high transparency PET substrate 5 is a thin film made of polyethylene terephthalate polymer through biaxial stretching and under the structure, serves as the substrate of anti-peeping layer structure resin, with a thickness of 25 microns; the silicone layer 6 is made of silicone resin through thermal curing; and the PET release film 7 is a PET polyester film that is, under the structure, used as an optical heavy release film with a thickness of 50 microns.

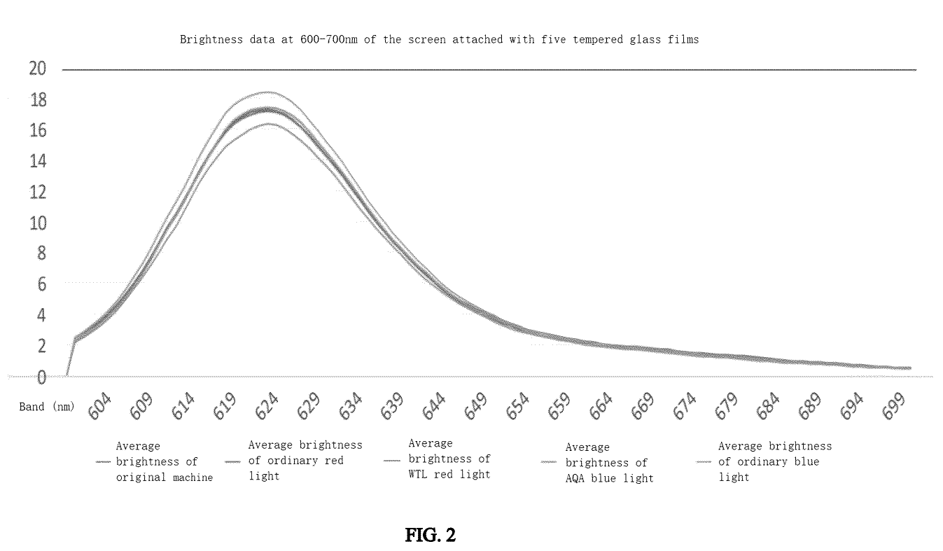

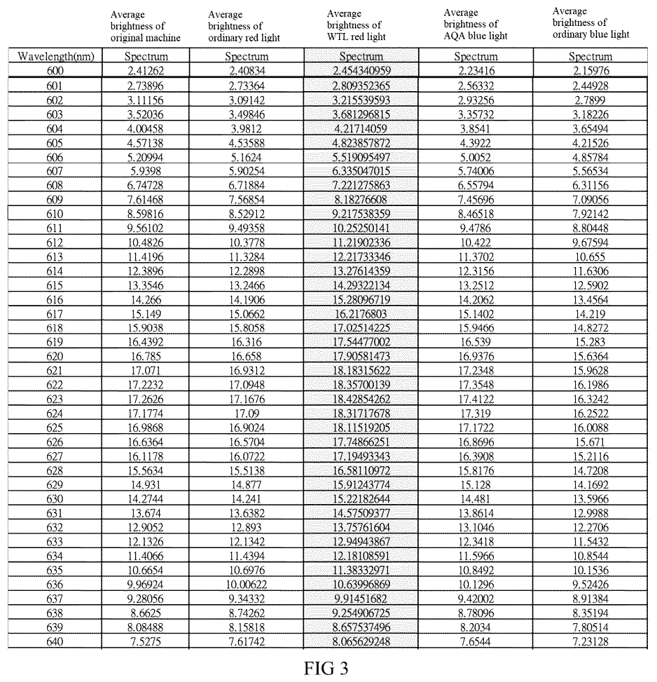

Working principle: The present invention provides a tempered glass film that blocks blue light and excites red light, comprising high-aluminum grade-3 strength glass 1, high transparency OCA 2, photo-excited carbon quantum dot coating 3, blue light blocking coating 4, high transparency PET substrate 5, silicone layer 6, and PET release film 7; the high aluminum grade-3 strength glass 1, which is treated with nano explosion-proof material, has a hardness as high as 9 times that of ordinary tempered glass film, and provides better eye protection effect; the high transparency OCA 2 adopts high transparency OCA adhesive, having high transmittance and low haze, minimal impact on the reflectivity of the anti-reflection film, strong adhesion, and excellent weather resistance, and the light cured OCA has good flatness and under the structure, has a thickness of 85 microns. The photo-excited carbon quantum dot coating 3 is a new type of nanomaterial that has attracted much attention for its unique luminescent properties, excellent biocompatibility and diverse surface functional groups. These functional groups can interact with other molecules to affect their electronic structure, and thus alter their luminescent properties, and the quantum dots have a particle size less than 10 nanometers, with high luminous intensity, quantum yield of 30%, and purity of 80%, the excitation wavelength of 400 nanometers, and emission wavelength of 610 nanometers; red light quantum dots can change the emission wavelength by adjusting the particle size, that is, smaller quantum dots emit light close to blue, while larger quantum dots emit light close to red, for example, blue light is emitted when the particle size of CdSe quantum dots is 2.1 nanometers, green light is emitted when the particle size is 5 nanometers, and red light is emitted when the particle size is 10 nanometers; in this structure, with a thickness of 15 nanometers, the carbon quantum dot of the photo-excited carbon quantum dot coating 3 has a transmittance over 90%, which is comparable to the transmittance of general PET (polyethylene terephthalate) and glass, and is completely transparent in the non-excited state. The blue light blocking coating 4 is composed of a fluorescent powder, an organic light absorber, an ultraviolet absorber, a resin, and an organic filler, and the mass percentage content of each component is: 10-15% for fluorescent powder, 0-10% for organic light absorber, 0-10% for ultraviolet absorber, 15-20% for inorganic filler, and rest for resin; the coating can effectively filter out harmful blue light emitted in the blue light band and has a thickness of 15 microns under the structure; the blue light blocking coating 4 compounded by inorganic nanomaterials and polymer materials can accurately absorb blue light in the band range of 435 nm-440 nm, effectively block blue light transmission, while ensuring the transmission of visible light of 440 nm-780 nm, without affecting the perspective and lighting performance. FIG. 3 shows the light transmittance of the present invention in the wavelength range of 380-460 nanometers. The high transparency PET substrate 5 is a thin film made of polyethylene terephthalate polymer through biaxial stretching, optical grade PET polyester film has features of high light transmittance, low haze, high brightness, no yellowing, good adhesion, good flatness, no light and dark lines, high temperature resistance and ultraviolet irradiation resistance, ideal stiffness, resistance to burning and cracking, and toughness, and under the structure, it serves as the substrate of anti-peeping layer structure resin, with a thickness of 25 microns. The silicone layer 6 is made of organic silicone resin through thermal curing. The PET release film 7 is a PET polyester film that is, under the structure, used as an optical heavy release film with a thickness of 50 microns. The red light AB adhesive on the market can only increase the amplification of red light to about 20%, while the present invention increases the amplification of red light band to more than 40%. It can be observed from FIG. 2 that the present invention provides the highest red light brightness in the 620 nanometer band, which is significantly better than the conventional level, and it can be found that compared with the three mainstream tempered glass films and the original machine, the present invention is particularly outstanding in brightness in the key band of 600-620 nanometers. The red light AB adhesive on the market usually presents light red, causing the screen hue to shift red and affect the chromaticity performance, while the carbon quantum dots used in the present invention are completely transparent, and only appear red when excited, so it will not affect the chromaticity of the screen during normal use. The red light AB adhesive on the market usually does not support blue light blocking, with blue light blocking rate generally of only 10-20%, while the present invention effectively blocks blue light with blocking rate of blue light band (435-440 nm) above 40%, and excites eye-friendly red light by using harmless purple light.

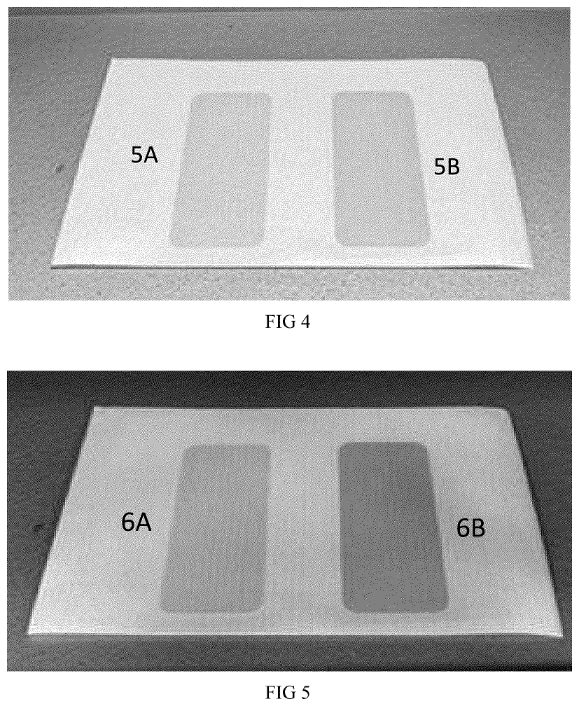

FIG. 4 is a schematic diagram of an experiment under a general light source (i.e. natural light) in the present application, 5A is a picture of the tempered glass film that blocks blue light and excites red light, while 5B is a picture of a regular tempered glass film that blocks blue light and obviously, the tempered glass film in the present application has better blue light blocking effect. FIG. 5 is a schematic diagram of the experiment under 380 nm designated laser band light source in the present application, shows the 380 nm designated laser band light source, and 6A is a picture of the tempered glass film that blocks blue light and excites red light, and 6B is a picture of a regular tempered glass film that blocks blue light and obviously, the tempered glass film in the present application has better blue light blocking effect.

For those skilled in the art, obviously, the present invention is not limited to the details of the exemplary embodiments described above, and can be implemented in other specific forms without departing from the spirit or essential features of the present invention. Therefore, from any point of view, the embodiments shall be regarded as exemplary and non limiting, and the scope of the present invention is limited by the appended claims rather than the above description. Therefore, it is intended to encompass all variations falling within the meaning and scope of the equivalent elements of the claims within the scope hereof. Any reference numerals in the claims shall not be regarded as limiting the claims involved.

What is claimed is:

1. A tempered glass film that blocks blue light and excites red light, comprising a high transparency PET substrate, wherein a blue light blocking coating is fixedly connected to an outer wall at a side of the high transparency PET substrate, a photo-excited carbon quantum dot coating is provided at a side of the blue light blocking coating, and a high transparency OCA is provided at a side of the photo-excited carbon quantum dot coating.

2. The tempered glass film of claim 1, wherein a high-aluminum grade-3 strength glass is fixedly connected to an outer wall at a side of the high transparency OCA.

3. The tempered glass film of claim 1, wherein a silicone layer is provided on the other side of the high transparency PET substrate, and a PET release film is provided on an outer wall at a side of the silicone layer.

4. The tempered glass film of claim 1, wherein the high transparency OCA is high transparency OCA adhesive having a thickness of 85 microns under the structure.

5. The tempered glass film of claim 1, wherein the photo-excited carbon quantum dot coating is a new type of nanomaterial, with quantum dot particle size less than 10 nanometers, quantum yield of 30%, purity of 80%, excitation wavelength of 400 nanometers, and emission wavelength of 610 nanometers.

6. The tempered glass film of claim 1, wherein the blue light blocking coating is composed of a fluorescent powder, an organic light absorber, an ultraviolet absorber, a resin, and an organic filler, and the mass percentage content of each component is: 10-15% for fluorescent powder, 0-10% for organic light absorber, 0-10% for ultraviolet absorber, 15-20% for inorganic filler, and the rest for resin.

7. The tempered glass film of claim 6, wherein the blue light blocking coating has a thickness of 15 microns under the structure.

8. The tempered glass film of claim 1, wherein the high transparency PET substrate is a thin film made of polyethylene terephthalate polymer through biaxial stretching and under the structure, serves as the substrate of anti peeping layer structure resin, with a thickness of 25 microns.

9. The tempered glass film of claim 3, wherein the silicone layer is made of silicone resin through thermal curing.

10. The tempered glass film of claim 3, wherein the PET release film is a PET polyester film that is, under the structure, used as an optical heavy release film with a thickness of 50 microns.
